(19) United States
(12) Patent Application Publication
(10) Pub. No.: US 2007/0065625 A1
(43) Pub. Date: Mar. 22, 2007

(54) Charcoal pad

(76) Inventor: Ching-Huo Lai, Taichung City (TW)

Correspondence Address: Ching-Huo Lai, 235 Chung - Ho, Taipei, 8-24, TW

(21) Appl. No.: 11/230,764

(22) Filed: Sep. 21, 2005

(51) Int. Cl. B32B 3/00

(52) U.S. Cl. 428/71; 428/68

(57) ABSTRACT

A charcoal pad comprises a foam main layer having an upper flat surface and a lower flat surface; a plurality of round receiving holes penetrating through the main layer; carbon powders being filled into the receiving holes; and two foam sub-layers glued to a top and a bottom of the main layer so as to form a charcoal pad with flat contact surfaces. A cloth layer may be used to enclose a periphery of the structure formed by the two sub-layers and the main layer. The cloth layer can be installed with a zipper. The charcoal pad is made as one of a pillar pad, a cushion, a car pad, a bed pad and a pet pad.

### FIELD OF THE INVENTION

The present invention relates to pads, and particularly to a charcoal pad which has uniform outer surfaces so that the user will feel easy and comfortable as laying upon it. Furthermore, the structure of the charcoal pad is tight so as to have a long lifetime.

### BACKGROUND OF THE INVENTION

The charcoals, such as white charcoal, with functions of emitting far infrared rays and negative ions are general used in daily life for providing the effect of medical treatment, air cleaning and other physical treatment effects. Thereby products with charcoals are widely used.

In one prior art, a plurality of small packets containing charcoals therein are arranged longitudinally and transversally. An enclosure serves to contain all the packets. The enclosure has an absorption layer. Non-weave cloth, net-like cloth and slide-stop cloth are used to the structure. Silicide is used to provide a comfortable feeling to the structure. The absorption layer has the effect of filtering powders. The structure can be used as a pad to make user feel comfortable. The absorption layer will emit far infrared rays and negative ions to improve the circulation of bloods, metabolism so as to increase the ability of immunity of human body.

However above mentioned prior art structure has the following disadvantages. Firstly, the structure is uneven since the structure of the packets are not uniform so that the user will feel uneasy as lying upon it. Furthermore, the structure is weak. The packets are formed as a plurality of independent sub-structures. It is possible that some packets fall out so that the full structure is destroyed. Thereby the pad must be deserted.

### SUMMARY OF THE INVENTION

Accordingly, the primary object of the present invention is to provide a charcoal pad which has uniform outer surfaces so that the user will feel easy and comfortable as lay on it. Furthermore, the structure of the charcoal pad is tight so as to have a long lifetime.

To achieve above objects, the present invention provides a charcoal pad which comprises a foam main layer having an upper flat surface and a lower flat surface; a plurality of round receiving holes penetrating through the main layer; carbon powders being filled into the receiving holes; and two foam sub-layers glued to a top and a bottom of the main layer so as to form a charcoal pad with flat contact surfaces. A cloth layer may be used to enclose an periphery of the structure formed by the two sub-layers and the main layer. The cloth layer can be installed with a zipper. The charcoal pad is made as one of a pillar pad, a cushion, a car pad, a bed pad and a pet pad.

The various objects and advantages of the present invention will be more readily understood from the following detailed description when read in conjunction with the appended drawing.

### BRIEF DESCRIPTION OF THE DRAWINGS

FIG. 1 is an exploded schematic view of the charcoal pad of the present invention.

FIG. 2 is an assembled schematic view about the charcoal pad of the present invention.

FIG. 3 is a partial cross sectional view about the charcoal pad with an enclosing layer of the present invention.

FIG. 4 is a partial schematic view of the charcoal pad of the present invention.

FIG. 5 is a perspective view showing that the charcoal pad of the present invention is combined with an active carbon net-like cloth.

FIG. 6 is a schematic perspective view showing one embodiment of the present invention, wherein the charcoal pad is made as a pillar pad.

FIG. 7 shows another embodiment of the present invention, where the present invention is made as a car pad.

FIG. 8 is an exploded schematic view showing that the present invention is made as a pet pad.

FIG. 9 is a partial schematic view of the pet pad in FIG. 8.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

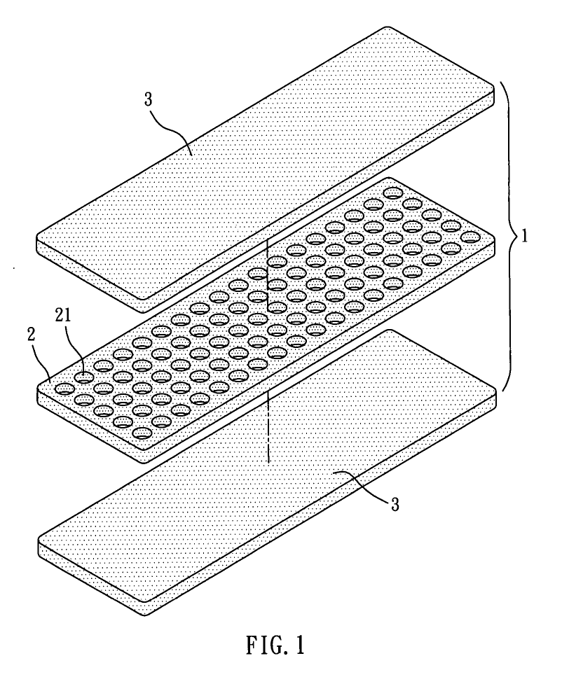

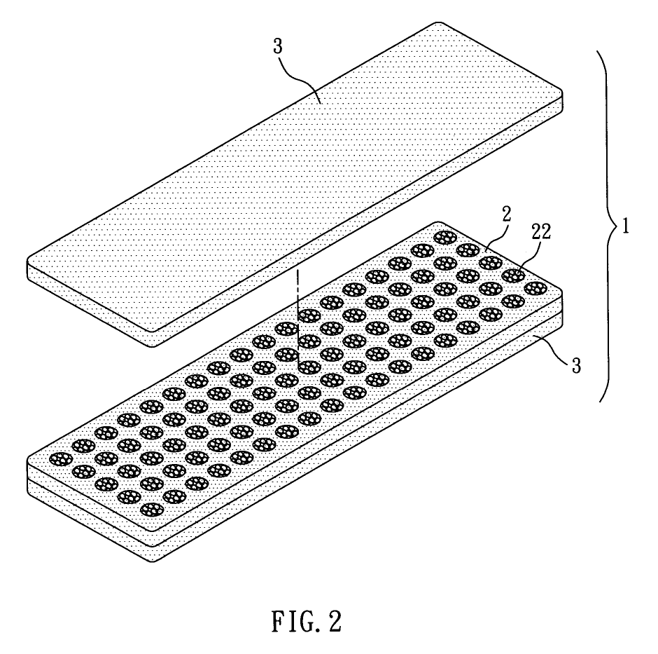

Referring to FIGS. 1 and 2 the charcoal pad 1 of the present invention is illustrated. The charcoal pad 1 has the following components.

A foam main layer 2 has an upper flat surface and a lower flat surface. A plurality of round receiving holes 21 penetrate through the main layer and are arranged along longitudinal and transversal directions. Carbon powders are filled into the receiving holes, the carbon powders are selected from charcoals, such as bamboo charcoals, white charcoals, etc.

Two foam sub-layers 3 are glued and combined to a top and a bottom of the main layer so as to form a charcoal pad 1 with flat contact surfaces.

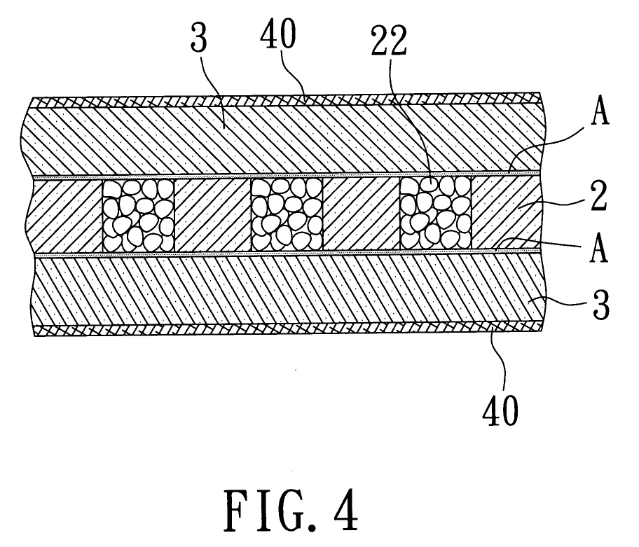

In the present invention, the carbons filled in the main layer emit far infrared rays and negative ions which can penetrate through the sub-layer 3. The glue for combining the main layer 2 and the sub-layer 3 may be fluid or solid glue, for example water glue A with prefer permeation, see FIG. 4. Thereby a charcoal pad 1 formed by the main layer 2 and the sub-layer 3 are formed. The carbon powders 22 are filled into the receiving holes 21 to be flushed with the upper surface and the lower surface of the main layer 2. Then the sub-layers 3 are adhered to the two sides of the main layer 2 by the glue. The carbons filled in the main layer emit far infrared rays and negative ions which can penetrate through the sub-layer 3. Thereby it can improve the blood circulation of people and speed the effect of metabolism. Thereby the negative ions have the effect of cleaning air.

Moreover the effect of the present invention has no directivity. The user may enjoy the effect of the charcoal pad 1 in any direction. Furthermore, since the carbon powders 22 are received in the receiving holes 21 tightly, it will not worry about that the carbon powders 22 will fall out. Thereby the carbon powders 22 can be filled into the receiving holes 21 automatically one time or several times (based on the area of the carbon powders 22). The machining work can be performed quickly.

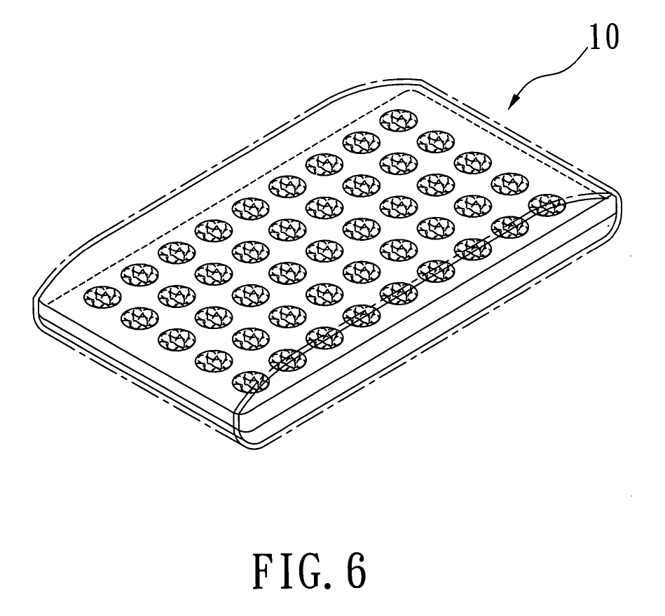

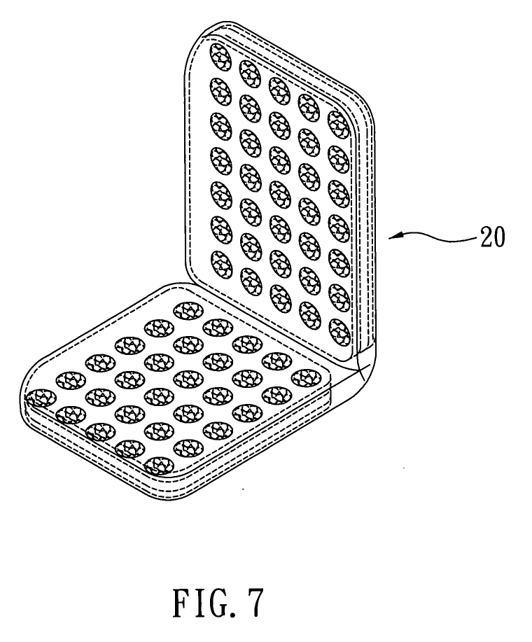

The shape of the charcoal pad 1 may be an oblong shape, a rectangular shape, a triangular shape, a round shape or other regular shape. Or the charcoal pad 1 has a shape of a pillar pad 10 illustrated in FIG. 6 or a car cushion 20 as illustrated in FIG. 7.

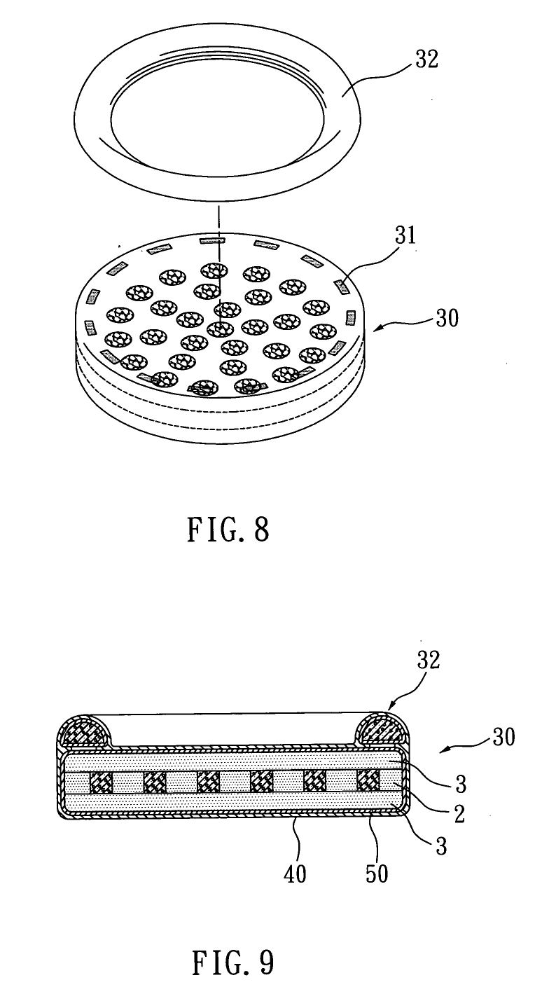

In FIG. 8, another embodiment of the present invention is illustrated, it is illustrated that the charcoal pad 1 has a round shape which is enclosed by an active carbon net-like cloth 50. An edge of a surface of the active carbon net-like cloth 50 is annularly installed with a plurality of sticky pads 31. Then an annular ring 32 containing carbon powders 22 therein is adhered to the sticky pads 31. Finally, a cloth layer 40 encloses the round charcoal pad 1 and the annular ring 32, see (referring to FIG. 9). Thereby a pet pad for dogs or cats is formed with physical treatment effects.

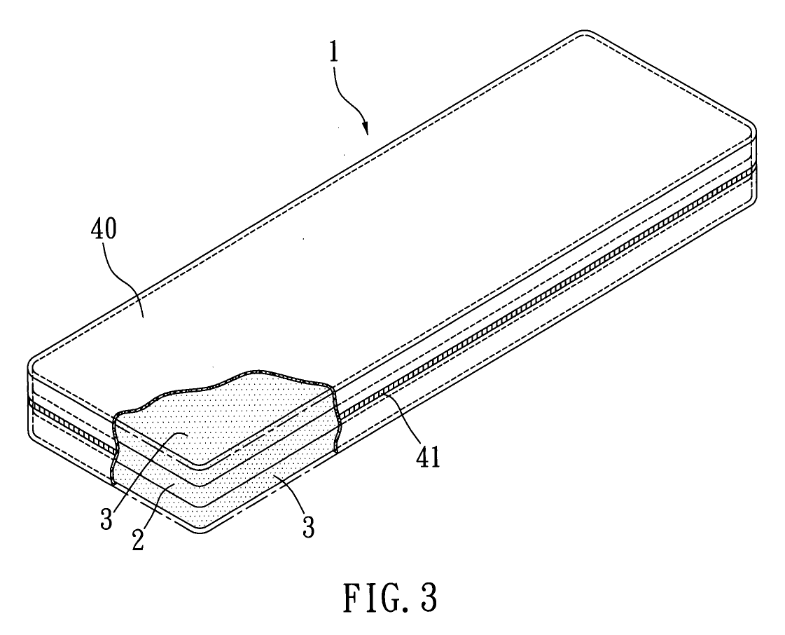

Referring to FIGS. 3 and 4, a cloth layer 40 can be used to enclose the charcoal pad 1. The cloth layer 40 has a zipper 41 for detaching the cloth layer 40 for cleaning and updating.

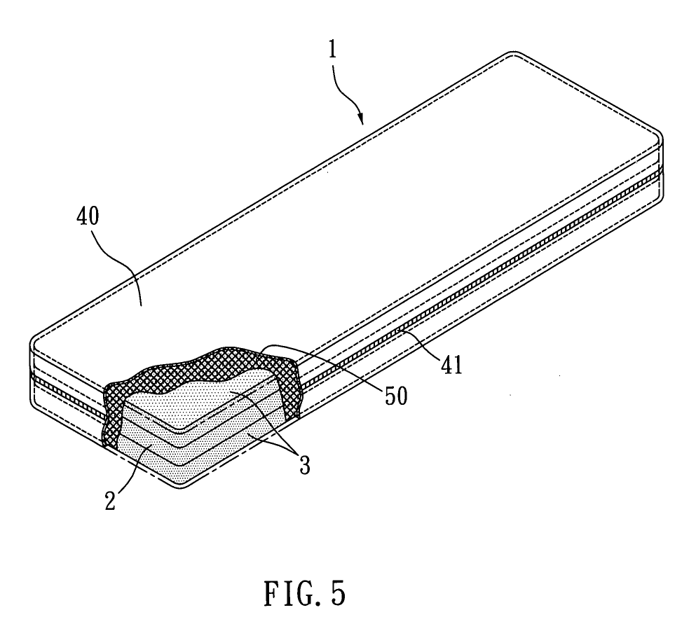

With reference to FIG. 5, to have preferred physical treating effects, an active carbon net-like cloth 50 is added to be connected the charcoal pad 1 and the cloth layer 40 so as to enhance the structure of the carbon powders to have preferred effect for emitting far-infrared ray and negative ions.

Furthermore, a high density foam can be used to make the main layer 2 and the sub-layers 3 of the charcoal pad 1 so as to increase the hardness of the structure.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A charcoal pad comprising:
a foam main layer having an upper flat surface and a lower flat surface;
a plurality of round receiving holes penetrating through the main layer; carbon powders being filled into the receiving holes;
two foam sub-layers glued to a top and a bottom of the main layer so as to form a charcoal pad with flat contact surfaces.

2. The charcoal pad as claimed in claim 1, wherein water glue is used to combine the main layer and sub-layers.

3. The charcoal pad as claimed in claim 1, wherein the plurality of round receiving holes are arranged along longitudinal and transversal directions.

4. The charcoal pad as claimed in claim 1, wherein the charcoal pad is made as one of a pillar pad, a cushion, a car pad, a bed pad and a pet pad.

5. The charcoal pad as claimed in claim 1, further comprising
a cloth layer enclosing an periphery of the structure formed by the two sub-layers and the main layer.

6. The charcoal pad as claimed in claim 1, wherein the carbon powders is selected from wood charcoals, bamboo charcoals, and white charcoals.

7. The charcoal pad as claimed in claim 1, wherein the main layer and sub-layers are made of high density foam materials.

8. The charcoal pad as claimed in claim 5, wherein an active carbon cloth is arranged between the cloth layer and the structure formed by the two sub-layers and the main layer.

9. The charcoal pad as claimed in claim 5, wherein the cloth layer has a zipper.

10. The charcoal pad as claimed in claim 8, wherein the cloth layer has a zipper.

11. The charcoal pad as claimed in claim 1, further comprising:
an active carbon net-like cloth enclosing a structure formed by the two sub-layers and the main layer;
a plurality of sticky pads annularly arranged around an edge of a surface of the active carbon net-like cloth;
an annular ring containing carbon powders adhered to the sticky pads; and
a cloth layer enclosing the round charcoal pad and the annular ring.
